(19) United States
(12) Patent Application Publication
(10) Pub. No.: US 2025/0033113 A1
(43) Pub. Date: Jan. 30, 2025

(54) HYBRID SOFT MAGNETIC MIXED POWDER, A METHOD OF PREPARING THE SAME, AND A METHOD OF PREPARING A HYBRID SOFT MAGNETIC MATERIAL

(71) Applicants: HYUNDAI MOTOR COMPANY, Seoul (KR); KIA CORPORATION, Seoul (KR)

(72) Inventors: Shin Gyu Kim, Hwaseong-si (KR); Jin Woo Kim, Dangjin-si (KR); Joon Chul Yun, Incheon (KR); Hyun Gon Lyu, Hwaseong-si (KR)

(73) Assignees: HYUNDAI MOTOR COMPANY, Seoul (KR); KIA CORPORATION, Seoul (KR)

(21) Appl. No.: 18/386,455

(22) Filed: Nov. 2, 2023

(30) Foreign Application Priority Data
Jul. 24, 2023 (KR) 10-2023-0096298

(51) Int. Cl. B22F 1/065; B22F 1/102; B22F 3/03; B22F 9/10

(52) U.S. Cl. CPC B22F 1/065; B22F 1/052; B22F 1/102; B22F 3/03; B22F 9/10; B22F 2009/0828; B22F 2301/355; B22F 2304/10; B22F 2998/10

(57) ABSTRACT

A hybrid-type soft magnetic mixed powder has improved compressibility and magnetic properties by mixing coarse alloy-based soft magnetic powder and fine pure iron-based soft magnetic powder. The hybrid-type soft magnetic mixed powder includes a mixture of 20 wt % to 50 wt % of a spherical alloy-based soft magnetic powder and 50 wt % to 80 wt % of an irregularly shaped pure iron-based soft magnetic powder. A method of forming the soft magnetic mixed powder includes mixing the alloy-based and iron-based powders and a soft magnetic material is formed using the soft magnetic mixed powder.

### CROSS REFERENCE TO RELATED APPLICATION

The present application claims priority to Korean Patent Application No. 10-2023-0096298, filed Jul. 24, 2023, the entire content of which is incorporated herein for all purposes by this reference.

### BACKGROUND OF THE DISCLOSURE

### Field of the Disclosure

The present disclosure relates to a hybrid-type soft magnetic mixed powder, a method of preparing the same, and a method of preparing a hybrid-type soft magnetic material. More specifically, the present disclosure relates to a hybrid-type soft magnetic mixed powder with improved compressibility and magnetic properties by mixing a coarse alloy-based soft magnetic powder and a fine pure iron-based soft magnetic powder, a method of preparing the same, and a method of preparing a hybrid-type soft magnetic material.

### Description of the Related Art

As the pace of electrification of global mobility has increased dramatically in recent years, the development of technologies to improve the performance of drive motors has become increasingly important.

The performance of a drive motor may be categorized into two areas: increasing torque and power and increasing energy efficiency.

In order to improve torque and power, the development of axial flux motors is active and soft magnetic powders with three-dimensional magnetic properties are attracting attention as core materials.

In addition, in order to increase energy efficiency, research and development on high revolutions per minute (RPM), i.e., high-frequency motors are increasing.

In general, regarding a range in which drive motors are operated, it is known that, in an operating range of 800 Hertz (Hz) or less, efficiency is better when an electric steel sheet is applied to a core rather than a soft magnetic powder. in contrast, in an operating range of 800 Hz or more, efficiency is better when a soft magnetic powder is applied to a core rather than an electric steel sheet.

Therefore, application of soft magnetic powder to a core is suitable for utilization of the axial flux motors described above. However, it is necessary to improve heat-related energy efficiency characteristics compared to electric steel sheets in a low-frequency range, which is a general operating condition. Thus, various technologies are being studied.

For example, a pure iron-based soft magnetic powder is applied for high power, but an alloy-based soft magnetic powder with low hysteresis loss is required to increase efficiency in a low-frequency range. However, the alloy-based soft magnetic powder has limitations in that it undergoes plastic deformation with difficulty due to its relatively high hardness compared to that of the pure iron-based soft magnetic powder and cannot be molded into a large component such as a drive motor.

Therefore, in order to overcome these limitations, various techniques for adjusting the particle shape and size distribution of an alloy-based soft magnetic powder, purity, and lubricant have been introduced. However, these techniques are still not applied within the industry due to poor compressibility of the powder. In addition, because the price of an alloy-based soft magnetic powder and costs for modularization processing and equipment investment are excessively high, general use thereof is limited.

Meanwhile, in the related art, it has been proposed to maximize the filling rate in a die by preparing spherical particles in order to improve compressibility of an alloy-based soft magnetic powder. However, because the alloy-based soft magnetic powder undergoes only a small amount of plastic deformation, a bonding force between the particles after molding is poor and a separate adhesive is required to be added to maintain the shape. The additive that is added in this way eventually reduces the overall density and acts as a foreign substance in terms of magnetic properties. Thus, there is a disadvantage in that the additive acts as a factor in performance deterioration.

In addition, as another method, it has been proposed to mix a pure iron-based soft magnetic powder and an alloy-based soft magnetic powder to increase the density during molding and to have a physical bonding force between particles due to the pure iron-based soft magnetic powder which is excellent in terms of plastic deformation. However, in order to ensure the expected characteristics, a relatively large amount of a pure iron-based soft magnetic powder is required to be added. Accordingly, there are limitations in that a hysteresis loss improvement effect is limited. Also, application thereof in the actual industry is difficult because a molding pressure of 1,000 MPa or more is required.

In addition, when an alloy-based soft magnetic powder having a fine particle size is used, the alloy-based soft magnetic powder exhibits most of the frictional force during molding because the specific surface area of the alloy-based soft magnetic powder is larger than that of a relatively coarse pure iron-based soft magnetic powder. As a result, there is a disadvantage in that compressibility is significantly reduced even with the addition of a small amount of the alloy-based soft magnetic powder.

The description of the above background art is only for understanding the background of the present disclosure. Thus, the above description should not be taken as an admission that it corresponds to the related art already known to those of ordinary skill in the art.

### SUMMARY OF THE DISCLOSURE

The present disclosure provides a hybrid-type soft magnetic mixed powder with improved compressibility and magnetic properties by mixing a relatively coarse alloy-based soft magnetic powder and a relatively fine pure iron-based soft magnetic powder. The present disclosure also provides a method of preparing the same and a method of preparing a hybrid-type soft magnetic material.

The technical objects to be achieved by the present disclosure are not limited to the above-described technical objects. Other technical objects that are not mentioned should be more clearly understood by those of ordinary skill in the art from the following description of the present disclosure.

In one example, a hybrid-type soft magnetic mixed powder according to an embodiment of the present disclosure includes a mixture of 20 wt % to 50 wt % of a spherical alloy-based soft magnetic powder and 50 wt % to 80 wt % of an irregularly shaped pure iron-based soft magnetic powder.

In one example, the alloy-based soft magnetic powder includes an alloy-based soft magnetic core powder having an average particle size of 200 PM or more. The pure iron-based soft magnetic powder includes a pure iron-based soft magnetic core powder having an average particle size of 45 μm or less.

In one example, the alloy-based soft magnetic core powder is a Fe—Si-based alloy.

In one example, in the alloy-based soft magnetic powder, a first inorganic insulating layer is formed on a surface of the alloy-based soft magnetic core powder, and a first organic insulating layer is formed on a surface of the first inorganic insulating layer. In the pure iron-based soft magnetic powder, a second inorganic insulating layer is formed on a surface of the pure iron-based soft magnetic core powder, and a second organic insulating layer is formed on a surface of the second inorganic insulating layer.

In one example, each of the first inorganic insulating layer and the second inorganic insulating layer is formed of a phosphate film or a silicate film, and each of the first organic insulating layer and the second organic insulating layer is formed of a silicone resin-based film or an alumina resin-based film.

In one example, when each of the first inorganic insulating layer and the second inorganic insulating layer is the phosphate film, an amount of the first inorganic insulating layer is 0.05 wt % to 0.2 wt % based on 100 wt % of the alloy-based soft magnetic core powder, and an amount of the second inorganic insulating layer is 0.05 wt % to 0.2 wt % based on 100 wt % of the pure iron-based soft magnetic core powder. When each of the first inorganic insulating layer and the second inorganic insulating layer is the silicate film, an amount of the first inorganic insulating layer is 0.1 wt % to 0.2 wt % based on 100 wt % of the alloy-based soft magnetic core powder, and an amount of the second inorganic insulating layer is 0.1 wt % to 0.2 wt % based on 100 wt % of the pure iron-based soft magnetic core powder.

In one example, an amount of the first organic insulating layer is 0.1 wt % to 0.2 wt % based on 100 wt % of the alloy-based soft magnetic powder, and an amount of the second organic insulating layer is 0.1 wt % to 0.2 wt % based on 100 wt % of the pure iron-based soft magnetic powder.

In one example, the soft magnetic mixed powder further includes 0.2 wt % to 0.4 wt % of a lubricating powder based on 100 wt % of a total amount of the alloy-based soft magnetic powder and the pure iron-based soft magnetic powder.

In one example a method of preparing a hybrid-type soft magnetic mixed powder according to an embodiment of the present disclosure includes a first core powder preparing step of preparing a spherical alloy-based soft magnetic core powder. The method also includes a second core powder preparing step of preparing an irregularly shaped pure iron-based soft magnetic core powder. The method also includes a mixing step of mixing the alloy-based soft magnetic core powder and the pure iron-based soft magnetic core powder to prepare a mixed core powder. The method also includes an inorganic insulating layer forming step of forming an inorganic insulating layer on a surface of the mixed core powder. The method also includes an organic insulating layer forming step of forming an organic insulating layer on the surface of the mixed core powder, on which the inorganic insulating layer is formed.

In one example, in the first core powder preparing step, the alloy-based soft magnetic core powder has an average particle size of 200 μm or more. In the second core powder preparing step, the pure iron-based soft magnetic core powder has an average particle size of 45 μm or less.

In one example, in the first core powder preparing step, the alloy-based soft magnetic core powder includes 3 wt % to 10 wt % of Si, 85 wt % to 92 wt % of Fe, and 5 wt % to 12 wt % of an alloy element (Me). Me is at least one or two metals selected from a group consisting of chromium (Cr), aluminum (Al), nickel (Ni), cobalt (Co), or a combination thereof.

In one example, in the first core powder preparing step, the alloy-based soft magnetic core powder is molded by a centrifugal atomization process. In the second core powder preparing step, the pure iron-based soft magnetic core powder is molded by a water atomization process.

In one example, in the mixing step, the mixed core powder includes a mixture of 20 wt % to 50 wt % of the alloy-based soft magnetic core powder and 50 wt % to 80 wt % of the pure iron-based soft magnetic core powder.

In one example, the inorganic insulating layer forming step includes an inorganic coating solution preparation process for preparing an inorganic coating solution containing phosphoric acid or silicic acid. The inorganic insulating layer forming step also includes an inorganic insulating layer formation process for forming a first inorganic insulating layer on a surface of the alloy-based soft magnetic core powder and forming a second inorganic insulating layer on a surface of the pure iron-based soft magnetic core powder. The inorganic coating solution is sprayed onto the surface of the mixed core powder.

The organic insulating layer forming step includes an organic coating solution preparation process for preparing an organic coating solution including silicone resin or aluminum resin. The organic insulating layer forming step also includes an organic insulating layer formation process for forming a first organic insulating layer on a surface of a first inorganic insulating layer on the alloy-based soft magnetic core powder and forming a second organic insulating layer on a surface of a second inorganic insulating layer on the pure iron-based soft magnetic core powder. The organic coating solution is sprayed onto the surface of the mixed core powder, on which the inorganic insulating layer is formed.

In one example, the method further includes, after the organic insulating layer forming step, an additional mixing step of further mixing 0.2 wt % to 0.4 wt % of a lubricating powder based on 100 wt % of a total amount of the alloy-based soft magnetic powder and the pure iron-based soft magnetic powder.

In one example, a method of preparing a hybrid-type soft magnetic material according to an embodiment of the present disclosure includes a mixed powder preparation process for preparing a mixed powder in which a spherical alloy-based soft magnetic powder and an irregularly shaped pure iron-based soft magnetic powder are mixed. The method also includes a molding process for compression molding the mixed powder into a molded object having a predetermined shape by using a die heated to room temperature or a temperature lower than a melting point of a lubricating powder included in the mixed powder. The method also includes a heat treatment process for heat treating the molded object at a temperature of 500° C. to 800° C.

In one example, the mixed powder preparation process includes: a first core powder preparing step of preparing an alloy-based soft magnetic core powder; a second core powder preparing step of preparing a pure iron-based soft magnetic core powder; a mixing step of mixing the alloy-based soft magnetic core powder, the pure iron-based soft magnetic core powder, and the lubricating powder to prepare a mixed core powder; an inorganic insulating layer forming step of forming an inorganic insulating layer on a surface of the mixed core powder; and an organic insulating layer forming step of forming an organic insulating layer on the surface of the mixed core powder, on which the inorganic insulating layer is formed.

In one example, in the first core powder preparing step, the alloy-based soft magnetic core powder has an average particle size of 200 μm or more. In the second core powder preparing step, the pure iron-based soft magnetic core powder has an average particle size of 45 μm or less.

In one example, the molded object that has undergone the heat treatment process has a magnetic flux density of 1.4 T or more and a coercive force of less than 120 A/m in a 10,000 A/m applied magnetic field. The molded object also has a hysteresis loss of 80 W/kg or less under conditions of 1 T and 1 kHz.

According to an embodiment of the present disclosure, the following effects can be expected.

First, via a combination of an alloy-based soft magnetic powder with low hysteresis loss and a pure iron-based soft magnetic powder with excellent magnetic flux density, advantages of both powders can be expected.

Second, eddy-current loss can be effectively reduced by forming a composite insulating film including an inorganic and organic materials on each of surfaces of the alloy-based soft magnetic powder and pure iron-based soft magnetic powder by utilizing a fluidized bed coating method.

Third, high compressibility can be ensured by mixing the alloy-based soft magnetic powder having a spherical coarse particle size, which is prepared by applying a centrifugal atomization process, and the pure iron-based soft magnetic powder having an irregularly shaped fine particle size, which is prepared by applying a water atomization process. Mixing the alloy-based and pure iron-based soft magnetic powders according to the foregoing provides a method for minimizing the specific surface area of the alloy-based soft magnetic powder and maximizing the specific surface area of the pure iron-based soft magnetic powder.

Fourth, a core prepared according to the present disclosure has a magnetic flux density of 1.4 T or more and a coercive force of less than 120 A/m in a 10,000 A/m applied magnetic field. The core also has a hysteresis loss of 80 W/kg or less under conditions of 1 T and 1 kHz. Accordingly, motors with excellent torque, excellent power, and excellent energy efficiency can be manufactured.

### BRIEF DESCRIPTION OF THE DRAWING

FIG. 1 is a cross-sectional view of a hybrid-type soft magnetic mixed powder according to an embodiment of the present disclosure.

### DETAILED DESCRIPTION OF THE DISCLOSURE

Hereinafter, embodiments disclosed in the present specification are described in detail with reference to the accompanying drawings. The same or similar components are indicated by the same reference numerals and redundant descriptions thereof are omitted.

The terms “ . . . module” and “. . . unit” for components, which are used in the following description, are given or used together in consideration of ease of writing the specification and do not have meanings or roles that are distinguished from each other by themselves.

In the description of the embodiments disclosed in the present specification, certain detailed explanations of the related art have been omitted where it has been deemed that the explanations would have unnecessarily obscured the essence of the embodiments disclosed in the present specification. In addition, the accompanying drawings are provided only to aid in understanding of the embodiments disclosed in the present specification. The technical idea disclosed in the present specification is not limited by the accompanying drawings. Also, it should be appreciated that all changes, equivalents, and substitutes that do not depart from the spirit and technical scope of the present disclosure are encompassed in the present disclosure.

Terms including ordinal numbers such as first and second may be used to describe various components, but the components are not limited by the terms. The terms are used only to distinguish one component from another component.

When a component is “connected” or “accessed” with another component, the component may be directly connected with or accessed with the other component. However, it should be understood that another component may exist therebetween. In contrast, when a component is “directly connected” or “directly accessed” with another component, it should be understood that another component does not exist therebetween.

The expression of singularity in the specification includes the expression of plurality unless clearly specified otherwise in context.

In the present specification, it is to be understood that the terms such as “including,” “having,” and “comprising” and variations thereof are intended to indicate the existence of the features, numbers, steps, actions, components, parts, or combinations thereof disclosed in the specification. Such terms are not intended to preclude the possibility that one or more other features, numbers, steps, actions, components, parts, or combinations thereof may exist or may be added.

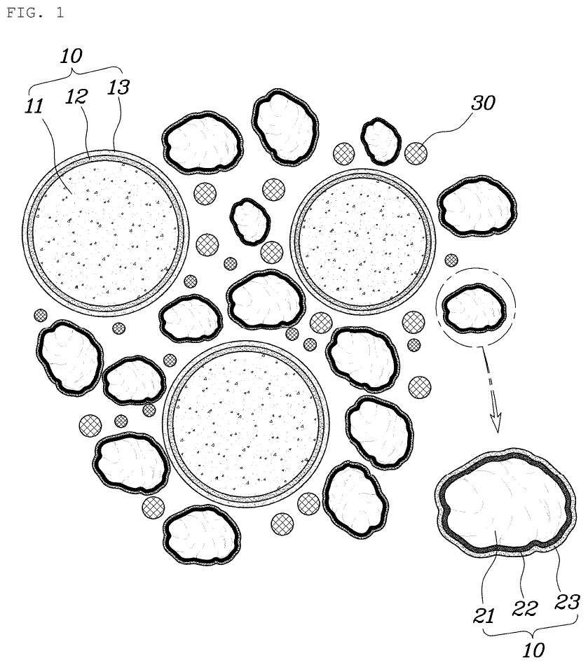

FIG. 1 is a cross-sectional view of a hybrid-type soft magnetic mixed powder according to an embodiment of the present disclosure.

As shown in FIG. 1, a hybrid-type soft magnetic mixed powder according to an embodiment of the present disclosure includes a mixture of a spherical alloy-based soft magnetic powder 10 and an irregularly shaped pure iron-based soft magnetic powder 20.

In addition, in the alloy-based soft magnetic powder 10, a first inorganic insulating layer 12 is formed on the surface of an alloy-based soft magnetic core powder 11. Also, a first organic insulating layer 13 is formed on the surface of the first inorganic insulating layer 12.

Likewise, in the pure iron-based soft magnetic powder 20, a second inorganic insulating layer 22 is formed on the surface of a pure iron-based soft magnetic core powder 21. Also, a second organic insulating layer 23 is formed on the surface of the second inorganic insulating layer 22.

The alloy-based soft magnetic powder 10 has the first inorganic and organic insulating layers 12 and 13 sequentially formed on the surface of the alloy-based soft magnetic core powder 11. The pure iron-based soft magnetic powder 20 has the second inorganic and organic insulating layers 22 and 23 sequentially formed on the surface of the pure iron-based soft magnetic core powder 21. This forms a composite insulating film including an inorganic material and an organic material.

In this case, as an example, in order to improve compressibility of the soft magnetic mixed powder, the alloy-based soft magnetic powder 10 is mixed with the alloy-based soft magnetic core powder 11, which is relatively coarse. Further, the pure iron-based soft magnetic powder 20 is mixed with the pure iron-based soft magnetic core powder 21, which is relatively fine.

For example, the alloy-based soft magnetic powder 10 includes the alloy-based soft magnetic core powder 11 having an average particle size of 200 μm or more. In one example, the alloy-based soft magnetic core powder 11 may have an average particle size of 300 μm or more, and more specifically, 400 μm or more. As the particle size of a powder increases, the specific surface area of the particles decreases relative to the weight of the particles, which is more advantageous in increasing molding density. However, impurities are inevitably generated in a process for manufacturing alloy molten steel. Because the impurities are generated as particles having a size of 425 μM or more, it may be advantageous to sort and use only particles of 425 μm or less for the alloy-based soft magnetic core powder.

In addition, the pure iron-based soft magnetic powder 20 includes the pure iron-based soft magnetic core powder 21 having an average particle size of 45 μm or less. In one example, the pure iron-based soft magnetic powder 20 is small enough to sufficiently cover the surface of the alloy-based soft magnetic powder 10 while being mixed with the alloy-based soft magnetic powder 10. In one example, the particle size of the pure iron-based soft magnetic powder 20 is 1/7 of the particle size of the alloy-based soft magnetic powder 10. More specifically, it may be most effective when the particle size of the pure iron-based soft magnetic powder 20 is 1/10 or less of the particle size of the alloy-based soft magnetic powder 10. Therefore, the pure iron-based soft magnetic powder 20 may have an average particle size of 45 μm or less. More specifically, the average particle size may be 35 fan or less, or even more specifically, 25 μm or less.

In addition, the particle size of the pure iron-based soft magnetic powder 20 has no lower limit. The reason is that it is advantageous as the particle size of the pure iron-based soft magnetic powder 20 decreases, but as the particle size decreases, manufacturing costs of the pure iron-based soft magnetic powder 20 increase exponentially.

The alloy-based soft magnetic core powder 11 may be an iron-silicon (Fe—Si)-based alloy containing Si. In this case, the alloy-based soft magnetic core powder 11 may further contain other alloy elements to improve its physical properties. For example, an alloy element (Me) additionally contained in the Fe—Si-based alloy may be at least one or two metals selected from the group consisting of chromium (Cr), aluminum (Al), nickel (Ni), cobalt (Co), or a combination thereof.

Therefore, the alloy-based soft magnetic core powder 11 may include 3 wt % to 10 wt % of Si, 85 wt % to 92 wt % of Fe, and 5 wt % to 12 wt % of Me.

In this case, the amount of Fe may be 85 wt % or more, or more specifically, 90 wt % or more. As the amount of Fe increases, magnetic flux density and magnetic permeability increase, which may be advantageous in terms of motor power. However, as the amount of Fe increases, specific resistance decreases, resulting in an increase in iron loss and core loss, which is disadvantageous in terms of motor efficiency. Thus, in one example, the upper limit value may be set at 92 wt % in order to maintain an appropriate amount and proportion of Si.

The amount of Si may be 3 wt % or more, or more specifically, may be 6.5 wt %, which is excellent in magnetic properties. When the amount of Si is 6.5 wt %, the best magnetic properties are exhibited. However, in the present disclosure, the alloy-based soft magnetic powder 10 is mixed with the pure iron-based soft magnetic powder 20. Thus, in one example, the amount of Si may be close to 6.5 wt % based on a total composition of the mixed powder. Therefore, in one example, the lower limit value of the amount of Si may be set at 3 wt %.

In addition, in one example, the upper limit value of the amount of Si may be set at 10 wt %. The reason is that, because Si reacts with Fe to form a regular lattice structure having high brittleness, as the amount of Si increases, it becomes disadvantageous in terms of compressibility.

Also, in one example, the total amount of the alloy element (Me) further added to the alloy-based soft magnetic core powder 11, in addition to Si and Fe, is 5 wt % to 12 wt % in consideration of the amounts of Si and Fe.

As described above, the alloy metal (Me) contained in the alloy-based soft magnetic core powder 11, in addition to Si and Fe, is at least one or two metals selected from the group consisting of Cr, Al, Ni, Co, and a combination thereof.

In one example, the alloy-based soft magnetic core powder 11 is formed to have a spherical shape and is prepared by a centrifugal atomization process in order to have a desired particle size. As the alloy-based soft magnetic core powder 11 is prepared by the centrifugal atomization process, it is possible to suppress a problem in which compressibility and magnetic properties deteriorate due to the formation of an iron oxide film on the surface of a powder due to an oxidation reaction with water. This is a problem caused when the powder is prepared by a water atomization process in the related art.

Next, the pure iron-based soft magnetic core powder 21 may be pure iron. In this case, in the pure iron, the amount of Fe is required to satisfy 99 wt % or more, and the amounts of metal elements added as necessary and impurities that are inevitably contained may be 1 wt % or less. However, elements to be contained in addition to Fe increase the hardness of the pure iron-based soft magnetic core powder 21, which is disadvantageous in terms of deformation and deteriorates magnetic properties. Thus, in one example, the upper limit value may be necessarily set at 1 wt %.

In one example, as the pure iron-based soft magnetic core powder 21, a powder prepared by a water atomization process is used to embody an irregular particle shape. The reason is that the spherical pure iron-based soft magnetic core powder 21 does not have sufficient molding strength due to a small amount of deformation during molding. The irregularly shaped pure iron-based soft magnetic core powder 21 has good strength because a cold-welding effect is maximized by many deformations during molding.

Meanwhile, as described above, the first inorganic and organic insulating layers 12 and 13 are sequentially formed on the surface of the alloy-based soft magnetic powder 11. The second inorganic and organic insulating layers 22 and 23 are sequentially formed on the surface of the pure iron-based soft magnetic core powder 21, to form a composite insulating film including an inorganic material and an organic material.

For example, each of the first inorganic insulating layer 12 formed on the surface of the alloy-based soft magnetic core powder 11 and the second inorganic insulating layer 22 formed on the surface of the pure iron-based soft magnetic core powder 21 may be formed of a phosphate film or a silicate film.

In addition, each of the first organic insulating layer 13 formed on the first inorganic insulating layer 12 on the alloy-based soft magnetic core powder 11 and the second organic insulating layer 23 formed on the second inorganic insulating layer 22 on the pure iron-based soft magnetic core powder 21 may be formed of a silicone resin-based film or an alumina resin-based film.

In this case, when each of the first inorganic insulating layer 12 and the second inorganic insulating layer 22 is the phosphate film, the amount of the first inorganic insulating layer 12 may be 0.05 wt % to 0.2 wt % based on 100 wt % of the alloy-based soft magnetic core powder 11. Also, the amount of the second inorganic insulating layer 22 may be 0.05 wt % to 0.2 wt % based on 100 wt % of the pure iron-based soft magnetic core powder 21.

In addition, when each of the first inorganic insulating layer 12 and the second inorganic insulating layer 22 is the silicate film, the amount of the first inorganic insulating layer 12 may be 0.1 wt % to 0.2 wt % based on 100 wt % of the alloy-based soft magnetic core powder 11. Also, the amount of the second inorganic insulating layer 22 may be 0.1 wt % to 0.2 wt % based on 100 wt % of the pure iron-based soft magnetic core powder 21.

When the amounts of the first inorganic insulating layer 12 and the second inorganic insulating layer 22 are greater than the above-described amounts, core density and magnetic flux density may decrease due to an excessively formed phosphate or silicate film, resulting in a decrease in motor power. In addition, when the amounts of the first inorganic insulating layer 12 and the second inorganic insulating layer 22 are less than the above-described amounts, specific resistance may decrease and core loss may increase due to a non-uniformly formed insulating film, resulting in a decrease in motor efficiency.

In addition, each of the first organic insulating layer 13 formed on the surface of the alloy-based soft magnetic powder 10 and the second organic insulating layer 23 formed on the surface of the pure iron-based soft magnetic powder 20 may be formed of a silicone resin-based film or an alumina resin-based film.

In this case, the amount of the first organic insulating layer 13 may be 0.1 wt % to 0.2 wt % based on the total 100 wt % of the alloy-based soft magnetic powder 10. Also, the amount of the second organic insulating layer 23 may be 0.1 wt % to 0.2 wt % based on the total 100 wt % of the pure iron-based soft magnetic powder 20.

When the amounts of the first organic insulating layer 13 and the second organic insulating layer 23 are greater than the above-described amounts, core density and magnetic flux density may decrease due to an excessively formed silica or alumina resin-based insulating film, resulting in a decrease in motor power. In addition, when the amounts of the first organic insulating layer 13 and the second organic insulating layer 23 are less than the above-described amounts, a defect occurs due to an excessively shrunk insulating film in a process for heat treating the mixed powder. Thus, specific resistance may decrease and core loss may increase, resulting in a decrease in motor efficiency.

Meanwhile, a hybrid-type soft magnetic mixed powder according to an embodiment of the present disclosure includes a mixture of the alloy-based soft magnetic powder 10 and the pure iron-based soft magnetic powder 20. In this case, in one example, the soft magnetic mixed powder includes a mixture of 20 wt % to 50 wt % of the alloy-based soft magnetic powder 10 and 50 wt % to 80 wt % of the pure iron-based soft magnetic powder 20. The reason is that 20 wt % or more of the alloy-based soft magnetic powder of the total composition is required to be added to ensure low hysteresis loss. However, due to the low compressibility of the alloy-based soft magnetic powder 10, addition of more than a critical amount reduces the overall density, making it difficult to achieve desired magnetic properties. Therefore, the amount of alloy-based soft magnetic powder 10 is limited not to be added more than 50 wt %.

Meanwhile, the soft magnetic mixed powder may further include a lubricating powder 30 to improve lubricity with a die during molding. In this case, in consideration of compressibility and magnetic properties of a component manufactured by the soft magnetic mixed powder, the mixing amount of the lubricating powder 30 may be set at 0.2 wt % to 0.4 wt % based on 100 wt % of a total amount of the alloy-based soft magnetic powder 10 and the pure iron-based soft magnetic powder 20.

Next, a method of preparing a hybrid-type soft magnetic mixed powder according to an embodiment of the present disclosure is described.

Meanwhile, a method of preparing a hybrid-type soft magnetic mixed powder according to an embodiment of the present disclosure includes a first core powder preparing step of preparing the spherical alloy-based soft magnetic core powder 11. The method also includes a second core powder preparing step of preparing an irregularly shaped pure iron-based soft magnetic core powder 21. The method also includes a mixing step of mixing the alloy-based soft magnetic core powder 11 and the pure iron-based soft magnetic core powder 21 to prepare a mixed core powder. The method further includes an inorganic insulating layer forming step of forming the first and second inorganic insulating layers 12 and 22 on the surface of the mixed core powder. The method also includes an organic insulating layer forming step of forming the first and second organic insulating layers 13 and 23 on the surface of the mixed core powder, on which the first and second inorganic insulating layers 11 and 22 are formed. In addition, the method may further include, after the organic insulating layer forming step, an additional mixing step of further mixing 0.2 wt % to 0.4 wt % of the lubricating powder 30 based on 100 wt % of a total amount of the alloy-based soft magnetic powder 10 and the pure iron-based soft magnetic powder 20.

The first core powder preparing step is a step of preparing the alloy-based soft magnetic core powder 11, which is relatively coarse and has a spherical shape, by a centrifugal atomization process. Also, as described above, the alloy-based soft magnetic core powder having an average particle size of 200 μm or more is prepared.

The alloy-based soft magnetic core powder 11 may include 3 wt % to 10 wt % of Si, 85 wt % to 92 wt % of Fe, and 5 wt % to 12 wt % of Me. In this case, Me is at least one or two metals selected from the group consisting of Cr, Al, Ni, Co, or a combination thereof.

The second core powder preparing step is a step of preparing the pure iron-based soft magnetic core powder 21, which is relatively fine and has an irregular shape, by a water atomization process. As described above, the pure iron-based soft magnetic core powder 21 having an average particle size of 45 fan or less is prepared.

In the pure iron-based soft magnetic core powder 21, the amount of Fe is required to satisfy 99 wt % or more. The amounts of metal elements added as necessary and impurities that are inevitably contained may be 1 wt % or less.

The mixing step is a step of mixing the alloy-based soft magnetic core powder 11 and the pure iron-based soft magnetic core powder 21 to prepare a mixed core powder. The mixed core powder is a mixture of 20 wt % to 50 wt % of the alloy-based soft magnetic core powder 11 and 50 wt % to 80 wt % of the pure iron-based soft magnetic core powder 21.

The inorganic insulating layer forming step is a step of forming the first and second inorganic insulating layers 12 and 22 on the mixed core powder, i.e., respectively on the surfaces of the alloy-based soft magnetic core powder 11 and the pure iron-based soft magnetic core powder 21. The inorganic insulating layer forming step includes an inorganic coating solution preparation process for preparing an inorganic coating solution and includes an inorganic insulating layer formation process for forming the first and second inorganic insulating layers 12 and 22 by spraying the inorganic coating solution onto the surface of the mixed core powder.

The inorganic coating solution preparation process is a process for preparing an inorganic coating solution containing phosphoric acid or silicic acid.

Because the inorganic coating solution is required to have effective wettability on the surface of the powder, it is advantageous as the viscosity decreases. Also, as a suitable solvent, acetone which is excellent in terms of handling, productivity, and price may be used. In addition, in one example, the concentration of the inorganic coating solution satisfies 1 wt % to 10 wt %. In other examples, the concentration of the inorganic coating solution may satisfy 3 wt % to 7 wt %, or more specifically, 4 wt % to 6 wt %. In addition, the amount of the inorganic coating solution is added by 2 wt % to 6 wt % of the total composition, and in one example, satisfies 3 wt % to 5 wt %.

In addition, the inorganic insulating layer formation process is a process for forming an inorganic insulating film by spraying the inorganic coating solution onto the surface of the mixed core powder including a mixture of the alloy-based soft magnetic core powder 11 and the pure iron-based soft magnetic core powder 21. This causes an oxidation reaction between the alloy-based soft magnetic core powder 11, the pure iron-based soft magnetic core powder 21, and the inorganic coating solution. Further, via the inorganic insulating layer formation process, the first inorganic insulating layer 12 is formed on the surface of the alloy-based soft magnetic core powder 11, and the second inorganic insulating layer 22 is formed on the surface of the pure iron-based soft magnetic core powder 21.

In addition, the organic insulating layer forming step is a step of forming the first and second organic insulating layers 13 and 23 respectively on the surfaces of the first inorganic insulating layer 12 and the second inorganic insulating layer 22 respectively formed on the alloy-based soft magnetic core powder 11 and the pure iron-based soft magnetic core powder 21. The organic insulating layer forming step includes an organic coating solution preparation process and an organic insulating layer formation process for forming the first and second organic insulating layers 13 and 23 by spraying an organic coating solution onto the surface of the mixed core powder, on which the first and second inorganic insulating layers 12 and 23 are formed.

The organic coating solution preparation process is a process for preparing an organic coating solution including silicone resin or aluminum resin.

Because the organic coating solution is coated on the inorganic insulating film and then produced in the form of a dense film during a subsequent hardening process, various organic solvents may be applied. For example, ethyl alcohol (ethanol) may be used as a solvent. In this case, in one example, the concentration of the organic coating solution satisfies 2 wt % to 20 wt %. In other examples, the concentration of the inorganic coating solution may satisfy 6 wt % to 14 wt % or more specifically 8 wt % to 12 wt %. In addition, the amount of the organic coating solution is added by 2 wt % to 6 wt % of the total composition, and in one example, satisfies 3 wt % to 5 wt %.

In addition, the organic insulating layer formation process is a process for forming an organic insulating film by spraying the organic coating solution onto the surface of the mixed core powder, on which the inorganic insulating layers are formed, i.e., the surfaces of the first inorganic insulating layer 12 and the second inorganic insulating layer 22. Also, via the organic insulating layer formation process, the first organic insulating layer 13 is formed on the surface of the first inorganic insulating layer 12 on the alloy-based soft magnetic core powder 11, and the second organic insulating layer 23 is formed on the surface of the second inorganic insulating layer 22 on the pure iron-based soft magnetic core powder 21.

Meanwhile, after the organic insulating layer formation process, a separate hardening process may be performed to stabilize the organic insulating layers. In this case, a curing condition may be variously selected according to a solvent material of the organic coating solution. For example, when acetone is used as a solvent, curing is possible for 30 minutes to 180 minutes at a boiling point of 56° C. or higher of acetone. For other organic solvents, curing is possible via sufficient drying at a temperature greater than or equal to the boiling points hereof.

In addition, after the organic insulating layer forming step, an additional mixing step of further mixing 0.2 wt % to 0.4 wt % of the lubricating powder 30 based on 100 wt % of a total amount of the alloy-based soft magnetic powder 10 and the pure iron-based soft magnetic powder 20 in order to ensure lubricity for molding a component.

The lubricating powder 30 serves to reduce the frictional force between a die and a molded body and the frictional force between powder particles during molding. In particular, the lubricating powder 30 is necessary element to ensure high density of the molded body. Any lubricating powder used in the iron powder industry may be used.

In addition, a binding mixing technique may be applied to a process for adding the lubricating powder 30 in order to further improve compressibility. For example, when the lubricating powder 30 is heated to a temperature near the melting point thereof and then mixed with the alloy-based soft magnetic powder 10 and the pure iron-based soft magnetic powder 20, the lubricating powder 30 may be uniformly attached to the surfaces of the alloy-based soft magnetic powder 10 and the pure iron-based soft magnetic powder 20. Rearrangement of the powder during molding is thereby facilitated, and thus, a higher density may be ensured.

In addition, in one example, the lubricating powder 30 has a melting point of 80° C. or higher. To this end, ethylene bis stearamide may be added in an amount of 50 wt % or more in the total lubricating powder. Also, in order to impart high lubricity, metal stearate-based lubricating powder may be added in an amount of 30 wt % or more in the total lubricating powder. Further, an inorganic oxide-based lubricating powder for frictional force reduction may be added in an amount of 10 wt % or less. For example, boron oxide (B₂O₃) or the like may be used for the inorganic oxide-based lubricating powder for frictional force reduction.

For the binding mixing technique, a binder, which may be added by replacing a portion of the lubricating powder 30, serves to uniformly attach a lubricating material to the surface of the mixed core powder by heating the lubricating material to the melting point thereof or higher.

The binder may include a material same as that of the lubricating powder 30 or may include a metal stearate-based organic material having higher lubricity. In this case, when the amount of the binder replacing the lubricating powder 30 is greater than 0.3 wt %, the proportion of the lubricating powder present between particles of the mixed core powder rapidly decreases. This results in poor flowability and ultimately results in poor compressibility. Thus, the amount of the binder satisfies 0.1 wt % to 0.3 wt % based on 100 wt % of a total amount of the alloy-based soft magnetic powder and the pure iron-based soft magnetic powder.

Next, a method of preparing a soft magnetic material by using a hybrid-type soft magnetic mixed powder prepared via the above-described method is described.

A method of preparing a hybrid-type soft magnetic material according to an embodiment of the present disclosure includes a mixed powder preparation process for preparing a mixed powder in which the spherical alloy-based soft magnetic powder 10 and the irregularly shaped pure iron-based soft magnetic powder 20 are mixed. The method also includes a molding process for compression molding the mixed powder into a molded object having a predetermined shape by using a die heated to room temperature or a temperature lower than the melting point of a lubricating powder included in the mixed powder; and a heat treatment process for heat treating the molded object at a temperature of 500° C. to 800° C.

The mixed powder preparation process is a process for preparing a mixed powder including a mixture of the alloy-based soft magnetic powder 10 in which the first inorganic insulating layer 12 and the first organic insulating layer 13 are formed and the pure iron-based soft magnetic powder 20 in which the second inorganic insulating layer 22 and the second organic insulating layer 23 are formed. The mixed powder is prepared via the method of preparing the hybrid-type soft magnetic mixed powder described above, i.e., the first core powder preparing step, the second core powder preparing step, the mixing step, the inorganic insulating layer forming step, the organic insulating layer forming step, and the additional mixing step.

The molding process is a process for compression molding a powder mixture into a molded object having a predetermined shape by filling a die with the powder mixture. A molding method performed in the powder metallurgy field may be applied to the molding process.

For example, the soft magnetic mixed powder is uniaxially pressed at a compression pressure of 600 MPa to 1,000 MPa in a die heated to room temperature or to a temperature lower than the melting point of the lubricating powder to form a molded object. The molded object has a molding density of 7 g/cm² or more.

The heat treatment process is a process performed to remove residual stress generated in a molded product during molding. A heat treatment method performed in the powder metallurgy field may be applied to the heat treatment process.

For example, the heat treatment process may be performed in an inert atmosphere and may be typically performed in a nitrogen or argon atmosphere.

In addition, the heat treatment process needs to be performed at a temperature sufficiently lower than the thermal decomposition temperature of an insulating material, which forms a composite insulating film, in order to prevent damage to the composite insulating film. However, the lubricating powder needs to be completely removed and heat treatment at a temperature of at least 500° C. is required to remove residual stress generated during molding. Therefore, in the heat treatment process, heat treatment in one example may be performed at a temperature of 500° C. to 800° C. In other examples, the heat treatment process may be performed at a temperature of 550° C. to 750° C., or more specifically, 600° C. to 700° C.

The molded object that has undergone the heat treatment process has a magnetic flux density of 1.4 T or more in a 10,000 A/m applied magnetic field.

In addition, the molded object has a coercive force of less than 120 A/m and has a hysteresis loss of 80 W/kg or less under conditions of a frequency of 1 kHz and an induction of 1T.

Hereinafter, the present disclosure is described via Comparative Examples and Examples.

In an alloy-based soft magnetic powder, a Fe—Si-based alloy containing 6.5 wt % of Si was used for a spherical alloy-based soft magnetic core powder prepared by a centrifugal atomization process. In this case, the particle size of the alloy-based soft magnetic core powder was classified as less than 425 μm and 180 μm or more, and thus, the average particle size was 285 μm.

In addition, in the pure iron-based soft magnetic powder, pure iron containing 99.5 wt % or more of Fe was used for an irregularly shaped pure iron-based soft magnetic core powder prepared by a water atomization process. In this case, the pure iron-based soft magnetic core powder having a particle size of 45 μm or less was used.

In addition, an inorganic insulating layer forming step of forming a phosphoric acid insulating film by spraying a phosphate solution having a concentration of 6.5 wt % on the alloy-based soft magnetic core powder and the pure iron-based soft magnetic core powder on the basis of a fluidized bed coating method (MP-01, Powrex Corporation) was performed. Then, an organic insulating layer forming step of generating a secondary coating of an organic insulating film on the phosphoric acid film by spraying an alumina resin-based coating solution having a concentration of 1 wt % was performed.

Net, 0.3 wt % of an ethylene bis stearamide-based composite organic lubricating powder (Lube S, PMSOL Corporation) was mixed with the mixed powder in which the inorganic insulating layer and the organic insulating layer were formed.

In addition, while the mixing ratio of the alloy-based soft magnetic core powder and the pure iron-based soft magnetic core powder was changed as shown in Table 1 below, compression molding was performed at 80° C. and 1,000 MPa in a ring-shaped die having an inner diameter of 45 mm, an outer diameter of 55 mm, and a height of 5 mm. In addition, the molded core sample was heat-treated at 650° C. for 30 minutes in a nitrogen atmosphere.

The core sample prepared in the above method was wound with 40 turns each for a primary circuit and secondary circuit of the core sample for B-H measurement. Thus, the magnetic properties were evaluated and the molding density of the core sample was measured by the Archimedes method. Results thereof are shown in Table 1 below.

In particular, among Comparative Examples, Comparative Example 1 was a case where only a pure iron-based soft magnetic powder was used. Comparative Example 2 was a case where only a pure iron-based soft magnetic powder without being coated with an insulating film was used. Comparative Example 5 was a case where only an alloy-based soft magnetic powder was used.

TABLE 1

| | Soft magnetic | | | | | | | |
|---|---|---|---|---|---|---|---|---|
| | powder | | | | | | | |
| | composition | | | | | | Core loss ²⁾ | |
| | (wt %) | | | Magnetic | | | (W/kg) | |
| | | Pure | Molding | flux | Coercive | Maximum | | Eddy- |
| | Alloy- | iron- | density | density ¹⁾ | force | magnetic | Hysteresis | current |
| Category | based | based | (g/cm³) | (T) | (A/m) | permeability | loss | loss |
| Comparative | 0 | 100 | 7.5 | 1.55 | 140 | 200 | 99 | 14 |
| Example 1 | | | | | | | | |
| Comparative | 0 | 100 | 7.54 | 1.55 | 117 | 208 | 169 | 455 |
| Example 2 | | | | | | | | |
| Comparative | 10 | 90 | 7.44 | 1.53 | 127 | 328 | 98 | 26 |
| Example 3 | | | | | | | | |
| Example 1 | 30 | 70 | 7.23 | 1.46 | 110 | 474 | 68 | 21 |
| Example 2 | 50 | 50 | 7.05 | 1.4 | 97 | 464 | 59 | 16 |
| Comparative | 70 | 30 | 6.46 | 0.88 | 85 | 117 | 109 | 13 |
| Example 4 | | | | | | | | |
| Comparative | 100 | 0 | Unable to be molded, Unable to prepare specimens | | | | | |
| Example 5 | | | | | | | | |

¹⁾ Based on 10 kA/m,
²⁾ Based on 1 T-1 kHz

As shown in Table 1, in Examples 1 and 2 satisfying the condition suggested in the present disclosure, the magnetic flux density was 1.4 T or more and the coercive force was less than 120 A/m in an 10,000 A/m applied magnetic field. In addition, a condition in which the hysteresis loss is 80 W/kg or less was satisfied under conditions of 1 T and 1 kHz.

However, it could be confirmed that Comparative Example 1, in which only the pure iron-based soft magnetic powder was used, was excellent in terms of magnetic flux density, but the coercive force and the hysteresis loss were higher than those of Examples 1 and 2.

In particular, it could be confirmed that Comparative Example 2, in which an insulating film was not formed, had a significantly high hysteresis loss.

In the case of Comparative Example 3, the mixing amount of the alloy-based soft magnetic powder was less than the mixing proportion suggested in the present disclosure. It could be confirmed that like Comparative Example 1, Comparative Example 3 was excellent in terms of magnetic flux density, but the coercive force and the hysteresis loss were higher than those of Examples.

In addition, in the case of Comparative Example 4, the mixing amount of the alloy-based soft magnetic powder was greater than the mixing proportion suggested in the present disclosure. It could be confirmed that Comparative Example 4 was excellent in terms of coercive force, but the magnetic flux density and the hysteresis loss were worse than those of Examples.

In particular, in the case of Comparative Example 5, the pure iron-based soft magnetic powder was not added, and because molding was impossible, a sample could not be prepared.

Although the present disclosure has been described with reference to the accompanying drawings and various example embodiments described above, the present disclosure is not limited thereto, but is limited by the claims described below. Therefore, those of ordinary skill in the art can variously transform and modify the example embodiments of the present disclosure within the scope within the technical idea of the claims described below.

What is claimed is:

1. A hybrid soft magnetic mixed powder comprising a mixture of 20 wt % to 50 wt % of a spherical alloy-based soft magnetic powder and 50 wt % to 80 wt % of an irregularly shaped pure iron-based soft magnetic powder.

2. The hybrid soft magnetic mixed powder of claim 1, wherein:
the alloy-based soft magnetic powder comprises an alloy-based soft magnetic core powder having an average particle size of 200 μm or more; and
the pure iron-based soft magnetic powder comprises a pure iron-based soft magnetic core powder having an average particle size of 45 μm or less.

3. The hybrid soft magnetic mixed powder of claim 2, wherein the alloy-based soft magnetic core powder is an iron-silicon (Fe—Si)-based alloy.

4. The hybrid soft magnetic mixed powder of claim 2, wherein:
in the alloy-based soft magnetic powder, a first inorganic insulating layer is formed on a surface of the alloy-based soft magnetic core powder, and a first organic insulating layer is formed on a surface of the first inorganic insulating layer; and
in the pure iron-based soft magnetic powder, a second inorganic insulating layer is formed on a surface of the pure iron-based soft magnetic core powder, and a second organic insulating layer is formed on a surface of the second inorganic insulating layer.

5. The hybrid soft magnetic mixed powder of claim 4, wherein:
each of the first inorganic insulating layer and the second inorganic insulating layer is formed of a phosphate film or a silicate film; and
each of the first organic insulating layer and the second organic insulating layer is formed of a silicone resin-based film or an alumina resin-based film.

6. The hybrid soft magnetic mixed powder of claim 5, wherein:
when each of the first inorganic insulating layer and the second inorganic insulating layer is the phosphate film, an amount of the first inorganic insulating layer is 0.05 wt % to 0.2 wt % based on 100 wt % of the alloy-based soft magnetic core powder, and an amount of the second inorganic insulating layer is 0.05 wt % to 0.2 wt % based on 100 wt % of the pure iron-based soft magnetic core powder; and
when each of the first inorganic insulating layer and the second inorganic insulating layer is the silicate film, an amount of the first inorganic insulating layer is 0.1 wt % to 0.2 wt % based on 100 wt % of the alloy-based soft magnetic core powder, and an amount of the second inorganic insulating layer is 0.1 wt % to 0.2 wt % based on 100 wt % of the pure iron-based soft magnetic core powder.

7. The hybrid soft magnetic mixed powder of claim 4, wherein:
an amount of the first organic insulating layer is 0.1 wt % to 0.2 wt % based on 100 wt % of the alloy-based soft magnetic powder; and
an amount of the second organic insulating layer is 0.1 wt % to 0.2 wt % based on 100 wt % of the pure iron-based soft magnetic powder.

8. The hybrid soft magnetic mixed powder of claim 1, further comprising 0.2 wt % to 0.4 wt % of a lubricating powder based on 100 wt % of a total amount of the alloy-based soft magnetic powder and the pure iron-based soft magnetic powder.

9. A method of preparing a hybrid soft magnetic mixed powder, the method comprising:
a first core powder preparing step of preparing a spherical alloy-based soft magnetic core powder;
a second core powder preparing step of preparing an irregularly shaped pure iron-based soft magnetic core powder;
a mixing step of mixing the alloy-based soft magnetic core powder and the pure iron-based soft magnetic core powder to prepare a mixed core powder;
an inorganic insulating layer forming step of forming an inorganic insulating layer on a surface of the mixed core powder; and
an organic insulating layer forming step of forming an organic insulating layer on the surface of the mixed core powder, on which the inorganic insulating layer is formed.

10. The method of claim 9, wherein:
in the first core powder preparing step, the alloy-based soft magnetic core powder has an average particle size of 200 μm or more; and
in the second core powder preparing step, the pure iron-based soft magnetic core powder has an average particle size of 45 μm or less.

11. The method of claim 9, wherein, in the first core powder preparing step, the alloy-based soft magnetic core powder comprises 3 wt % to 10 wt % of silicon (Si), 85 wt % to 92 wt % of iron (Fe), and 5 wt % to 12 wt % of an alloy element (Me), and Me is at least one or two metals selected from a group consisting of chromium (Cr), aluminum (Al), nickel (Ni), cobalt (Co), or a combination thereof.

12. The method of claim 9, wherein:
in the first core powder preparing step, the alloy-based soft magnetic core powder is molded by a centrifugal atomization process; and
in the second core powder preparing step, the pure iron-based soft magnetic core powder is molded by a water atomization process.

13. The method of claim 9, wherein, in the mixing step, the mixed core powder comprises a mixture of 20 wt % to 50 wt % of the alloy-based soft magnetic core powder and 50 wt % to 80 wt % of the pure iron-based soft magnetic core powder.

14. The method of claim 9, wherein the inorganic insulating layer forming step comprises:
an inorganic coating solution preparation process for preparing an inorganic coating solution containing phosphoric acid or silicic acid; and
an inorganic insulating layer formation process for forming a first inorganic insulating layer on a surface of the alloy-based soft magnetic core powder and forming a second inorganic insulating layer on a surface of the pure iron-based soft magnetic core powder, the inorganic insulating layer formation process including spraying the inorganic coating solution onto the surface of the mixed core powder.

15. The method of claim 9, wherein the organic insulating layer forming step comprises:
an organic coating solution preparation process for preparing an organic coating solution including silicone resin or aluminum resin; and
an organic insulating layer formation process for forming a first organic insulating layer on a surface of a first inorganic insulating layer on the alloy-based soft magnetic core powder and forming a second organic insulating layer on a surface of a second inorganic insulating layer on the pure iron-based soft magnetic core powder, the organic insulating layer formation process including spraying the organic coating solution onto the surface of the mixed core powder on which the inorganic insulating layer is formed.

16. The method of claim 9, further comprising, after the organic insulating layer forming step, an additional mixing step of further mixing 0.2 wt % to 0.4 wt % of a lubricating powder based on 100 wt % of a total amount of the alloy-based soft magnetic powder and the pure iron-based soft magnetic powder.

17. A method of preparing a hybrid soft magnetic material, the method comprising:
a mixed powder preparation process for preparing a mixed powder in which a spherical alloy-based soft magnetic powder and an irregularly shaped pure iron-based soft magnetic powder are mixed;
a molding process for compression molding the mixed powder into a molded object having a predetermined shape by using a die heated to room temperature or a temperature lower than a melting point of a lubricating powder included in the mixed powder; and
a heat treatment process for heat treating the molded object at a temperature of 500° C. to 800° C.

18. The method of claim 17, wherein the mixed powder preparation process comprises:
a first core powder preparing step of preparing an alloy-based soft magnetic core powder;
a second core powder preparing step of preparing a pure iron-based soft magnetic core powder;
a mixing step of mixing the alloy-based soft magnetic core powder, the pure iron-based soft magnetic core powder, and the lubricating powder to prepare a mixed core powder;
an inorganic insulating layer forming step of forming an inorganic insulating layer on a surface of the mixed core powder; and
an organic insulating layer forming step of forming an organic insulating layer on the surface of the mixed core powder, on which the inorganic insulating layer is formed.

19. The method of claim 18, wherein:
in the first core powder preparing step, the alloy-based soft magnetic core powder has an average particle size of 200 μm or more; and
in the second core powder preparing step, the pure iron-based soft magnetic core powder has an average particle size of 45 μm or less.

20. The method of claim 17, wherein the molded object that has undergone the heat treatment process has a magnetic flux density of 1.4 T or more and a coercive force of less than 120 A/m in a 10,000 A/m applied magnetic field and has a hysteresis loss of 80 W/kg or less under conditions of 1 T and 1 kHz.
